(19) United States
(12) Patent Application Publication
(10) Pub. No.: US 2005/0018580 A1
(43) Pub. Date: Jan. 27, 2005

(54) Method and apparatus for rapidly accessing a physical position on an optical disc

(76) Inventor: Cornelis Marinus Schep, Eindhoven (NL)

Correspondence Address: Corporate Patent Counsel;Philips Electronics North America Corporation, PO Box 3001, Briarcliff Manor, NY, 10510, US

(21) Appl. No.: 10/495,822

(22) PCT Filed: Oct. 24, 2002
(86) PCT No.: PCT/IB02/04451

(30) Foreign Application Priority Data
Nov. 20, 2001 (EP) 01204425.1

(51) Int. Cl. G11B 7/085; G11B 5/09

(52) U.S. Cl. 369/59.23; 369/111; 369/59.25; 369/47.21; 369/30.03

(57) ABSTRACT

A method for manufacturing a record carrier and a record carrier comprising an optical disc having a lead-in portion storing information being indicative that a fixed relation is provided between the physical address of each error correction code (ECC) block and the corresponding position of each ECC block on the disc. Provides the possibility of fast access to the ECC blocks on the disc for recording and/or reading of data. May easily be applied to existing groove-only formats, such as CD-ROM, CD-R, CD-RW, DVD-ROM, DVD-R, DVD+R, DVD-RW, DVD+RW, and is therefore ‘backward compatible’. Furthermore, a device for recording and/or reading data on/from a record carrier. Is capable of reading the information in the lead-in portion and act accordingly, i.e. fast access if it is possible and normal access if not.

### FIELD OF THE INVENTION

The present invention relates generally to optical discs and more particularly to a method and apparatus for fast access to a physical position, such as the position of an error correction block, on the optical disc.

### BACKGROUND OF THE INVENTION

Present groove-only formats, such as read-only compact disc (CD-ROM), recordable compact disc (CD-R), rewritable compact disc (CD-RW), read-only digital versatile disc (DVD-ROM), recordable digital versatile disc (DVD-R, DVD+R), rewritable digital versatile disc (DVD-RW, DVR+RW), use a single spiral in which information is stored at constant linear density. The position along the track is indicated by some sort of address that is proportional to the number of channel bits on the track, such as the physical address (PA) in the ADIP of DVD+RW. The location on the disc in terms of track number and angular position is not fixed due to a number of factors, most notably the variation in linear density. This is a disadvantage for fast access. For example, a certain error correction code (ECC) block at a certain address is to be accessed, but it is not known precisely where this address is located on the disc in terms of track number and angular position. In a drive, this results in retries during access which adds to the total access time.

It is noted that access time becomes increasingly important, especially for high-speed data applications, such as CD-RW or DVD+RW replacing floppy drives in personal computers (PCs). As an illustration, for DVD+RW the linear density is allowed to vary by ±1.05%. The total length of the spiral equals 11836 m. The variation in length thus equals ±124 m. The length of a single track at radius 58 mm equals 0.364 m. The variation in track number for the PA's near the outer radius of the disc thus equals ±340. Even for jumps of a few hundred tracks the inaccuracy equals a few tracks. One attempt to address this problem proposes to synchronize the physical addresses with the track number and the angular position. The implementation of that solution, however, is a zoned-constant angular velocity (Zoned-CAV) scheme which has several disadvantages, such as bit length variations, a buffer track at the start of a new zone, and no possibility for implementation in present formats.

WO 98/25265 discloses a system with a disc-shaped record carrier. The information on the disc is represented by marks constituted by bit cells having a constant bit length. The difference in bit length from winding to winding is equal to an integral number of bits. Thereby the position of an information block somewhere in the track may be computed in a simple manner and with great accuracy. Thus, faster access to the information is ensured. However, a record carrier as disclosed in WO 98/25265 can not be used in existing drives. Furthermore, the system of WO 98/25265 may not be applied to all existing disc formats. Thus, for the known DVD formats, including the rewritable versions, such as DVD+RW and DVD+R, it is not possible to format the disc in such a way that the difference in bit length from winding to winding is an integral number of bits. This is due to the fact that the track pitch and the bit length are fixed and can not be modified, because a modification would result in the disc no longer being compatible with existing players. Furthermore, in disc formats where it is possible to format the disc in such a way that the difference in bit length from winding to winding is an integral number of bits, the chosen bit length may not be optimal for other purposes, e.g. the storage capacity of the disc may not be the highest possible.

### SUMMARY OF THE INVENTION

It is an object of the present invention to provide a record carrier which allows for fast access to the information on the record carrier, and which is compatible with existing drives.

It is a further object of the present invention to provide a method for allowing fast access to information on a record carrier, the method being suitable for use in existing disc formats.

It is an even further object of the present invention to provide a device for recording and/or reading information on a record carrier in such a way that the information may be accessed in a fast manner.

In a first aspect of the invention the above and other objects are fulfilled by a record carrier comprising an optical disc having:
a continuous spirally wound data area for recording and/or reading data at a substantially constant linear density,
a plurality of synchronizing elements in the data area, said plurality of synchronizing elements providing, for each error correction code (ECC) block residing on the data area, a fixed relation between the physical address of a given ECC block and the position on the data area of said ECC block,
a lead-in portion storing information being indicative of a specific format of the disc for accessing an ECC block.

In a second aspect of the invention the above and other objects are fulfilled by a method for manufacturing a record carrier, the method comprising the steps of:
providing an optical disc having a continuous wound data area for recording and/or reading data at a substantially constant linear density,
providing a plurality of synchronizing elements in the data area,
providing, for each error correction code (ECC) block residing on the data area and by means of said plurality of synchronizing elements, a fixed relation between the physical address of a given ECC block and the position on the data area of said ECC block,
providing a lead-in portion on said optical disc,
storing information in said lead-in portion being indicative of a specific format of the disc for accessing the ECC block.

In a third aspect of the invention the above and other objects are fulfilled by a device for recording and/or reading data on/from a record carrier, the record carrier comprising an optical disc having a continuous spirally wound data area for recording and/or reading data at a substantially constant linear density and a lead-in portion for storing information being indicative of a specific format of the disc for accessing a given error correction code (ECC) block residing on the data area, the device comprising:
means for reading information from the lead-in portion of the data area,
means for accessing the position of a given ECC block for reading and/or writing said ECC block while the accessing is performed, said accessing being performed according to the information read from the lead-in portion.

Referring to the first and second aspects of the present invention, the optical disc of the record carrier may be a compact disc, e.g. a CD-ROM, CD-R, or CD-RW, or it may be a digital versatile disc, e.g. a DVD-ROM, DVD-R, DVD-RW, or DVD+RW, or it may be any other suitable kind of optical disc.

The data of the optical disc is recorded at a substantially constant density since this provides the optimal use of the storage capacity of the optical disc.

The information being indicative of a specific format of the disc is preferably of a kind which informs the drive that the disc is of a kind which allows for fast access to the data stored on the disc. Thus, when the drive needs to access specific data on the disc (or, alternatively, ‘once and for all’ during start up), it may initially access the lead-in portion to check for this information. In case the disc is according to the present invention, the information in the lead-in portion will inform the drive that it may access the data in a fast manner. Thus, the drive knows that there exists a fixed relation between the physical address of a given ECC block and the position on the data area of said ECC block, and it may then calculate the position from the known physical address, thus providing a fast access to the ECC block.

If, on the other hand, the lead-in portion does not contain information indicating that the disc is according to the present invention, the drive will access the desired ECC block in an ordinary manner. Thus, a drive being capable of accessing data on a record carrier according to the present invention is also capable of accessing data on prior art record carriers. Furthermore, the present invention may easily be applied to existing record carrier formats. Thus, the record carrier of the present invention is ‘backward compatible’ with existing record carriers. This is a great advantage since it makes it possible to introduce a fast access possibility without having to introduce a new record carrier format.

Furthermore, a record carrier according to the present invention may be used in a drive which is not capable of performing the required calculations, and which may therefore not provide the fast access to the data. In this case the data on the record carrier is just accessed in the conventional (slower) manner. Thus, the record carrier according to the invention is also ‘backward compatible’ with existing drives. This is a great advantage since the new record carrier can be used in existing drives, although the possibility of fast access is lost in that case.

In particular the present invention may be applied to the known DVD formats, including its writable versions, such as DVD+RW and DVD+R. Furthermore, the track pitch and the bit length are not constricted by a condition that the difference in bit length from winding to winding must be an integral number of bits. Thus, the track pitch and bit length may be chosen in such a way that other factors are taken into consideration, e.g. in such a way that the capacity on the disc is the highest possible, or in such a way that sufficient margin is given for all sorts of deviation, such as tilt, defocus, etc. Thus, the present invention provides freedom to choose the track pitch and bit length without unnecessary constraints. This is very advantageous.

The position of an ECC block may further be defined according to a specification on the number of synchronizing elements after n rotations of the disc and a calculated nominal number of synchronizing elements after n rotations, where n is the track number.

Furthermore, the position of an ECC block may be defined according to an actual number of synchronizing elements after n rotations of the disc, equal to the nominal number of synchronizing elements after n rotations, with an accuracy of ±m synchronizing elements for any n rotations, in which case the lead-in portion preferably further stores information being indicative of the accuracy, m.

Thus, the requirements for the accuracy of the calculation of the position of the ECC block may be relaxed by allowing a certain accuracy. For example, the number of synchronizing elements after n rotations can deviate from the nominal number by ±m synchronizing elements. It should be noted that m is not necessarily an integer, but could be any number. Preferably, the specified accuracy is substantially less than one rotation, such as less than a half rotation.

Alternatively or additionally, the fixed relation between the physical address of an ECC block and the position on the data area of said ECC block may be defined in terms of a known relationship between the synchronizing elements and a track number and angle corresponding to the position of the ECC block.

The synchronizing elements may comprise, e.g., wobbles, channel bits, sub-code frames, sync frames, recording frames, physical sectors on the data area of the disc, and/or any other suitable kind of synchronizing elements.

The lead-in portion may further store the position of at least a substantial fraction of the ECC blocks residing on the data area. The position of all of the ECC blocks may be stored. Alternatively, only the position of a substantial fraction of the ECC blocks is stored. In this case the position of the remaining ECC blocks may be found by interpolation using the stored positions.

The method of the invention may further comprise the step of providing a coupling between disc rotation and write clock by means of the synchronizing elements.

Referring to the third aspect of the present invention, the position of the ECC block on the data area may further be defined according to an actual number of synchronizing elements after n rotations of the disc, equal to the a calculated nominal number of synchronizing elements after n rotations, with an accuracy of ±m synchronizing elements for any n rotations, in which case the information in the lead-in portion of the data area may further comprise information being indicative of the accuracy, m, and the means for reading information from the lead-in portion of the data area may further be adapted to reading information being indicative of the accuracy, m.

Furthermore, the device may be adapted to recognise a specific format of the disc based on the information being read from the lead-in portion.

### BRIEF DESCRIPTION OF THE DRAWINGS

FIG. 1a is a top view of a disc-shaped record carrier having a pre-groove intended for recording for use in an embodiment of the present invention,

FIG. 1b is a cross section of the record carrier of FIG. 1b along the line b-b,

FIG. 2 shows an example of a periodic modulation or wobble of the pre-groove,

FIG. 3 shows a device for reading information from a record carrier, and

FIG. 4 shows a device for writing information on a record carrier.

### DETAILED DESCRIPTION OF THE DRAWINGS

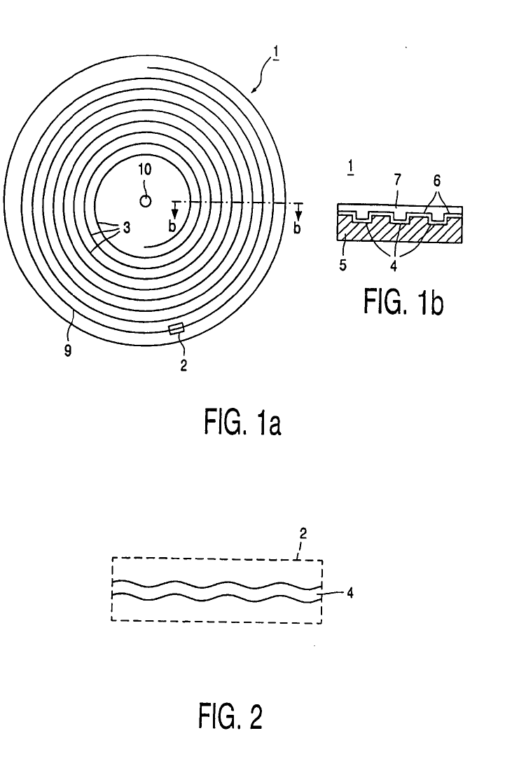

FIG. 1a shows a record carrier 1 provided with a track 9 intended for recording and a central hole 10. The track 9 is arranged in accordance with a spiral pattern of windings 3. FIG. 1b is a cross-section along the line b-b of the record carrier 1 of FIG. 1a, in which a transparent substrate 5 is provided with a recording layer 6 and a protective layer 7. The recording layer 6 may be optically writable, e.g. via phase change, or it may be magneto-optically writable by a device for writing information, such as the known CD-Rewritable or CD-Recordable. The recording layer may also be provided with information via a production process, in which first a master disc is made which is subsequently multiplied through pressing. The information is organised in information blocks, such as error correction code (ECC) blocks. In one embodiment, the track 9 on the record carrier of a rewritable type is indicated by a servopattern which is provided during the manufacture of the blank record carrier. The servopattern may be formed by a pre-groove 4 which enables a write head to follow the track during scanning. The pre-groove may be implemented as a deeper or a raised part, or as a material property deviating from its ambience. Alternatively, the servopattern may consist of an alternation of elevated and deeper windings, referred to as land and groove patterns, with a transition form land to groove or vice versa taking place per winding.

The recording area is provided with a plurality of synchronizing elements, such as wobbles. The synchronizing elements provide a fixed relation between the physical address of a given ECC block and the actual position of the ECC block on the recording area in terms of track number and angle.

A lead-in area is disposed proximate the inner diameter of the active data area of the pre-groove 4, and a lead-out area is disposed proximate the outer diameter of the active data area of the pre-groove 4. As a method of writing data on the optical disc 1 without forming address information in units of one sector, the data is written in units of one ECC block, in which error correcting codes are included for correcting errors anywhere in the ECC block. Referring to FIG. 1, an embodiment of the present invention achieves on the record carrier 1 a constant linear density, wherein the position of ECC blocks on the disc 1 are fixed and known in terms of a track number and an angle.

The lead-in portion comprises information being indicative of a specific format of the disc 1. When a certain ECC block is to be accessed, the drive uses the information in the lead-in portion to decide whether or not the disc 1 is of a type which allows fast access of the ECC block. In case the disc is of such a kind, the drive uses this information to derive that a fixed relation exists between the physical address of the ECC block and the actual position of the ECC on the recording area in terms of track number and angle. Applying this, the drive can easily find the ECC block in question using the physical address. In case the disc is not of such a kind, the ECC block is accessed in a normal manner.

FIG. 2 shows an example of a periodical variation of a physical parameter of the pre-groove 4, called a wobble. The periodical variation of this example is a variation of the lateral position. The wobble produces a wobble signal in a tracking servosensor. The wobble is, e.g., frequency modulated, and the position information, such as an address, a time code or winding information is coded in the modulation. A servopattern may also consist of, e.g., regularly distributed sub-patterns which periodically cause tracking signals. Further, the servopattern may include modifications of the land area beside the pre-groove 4, e.g. and undulating pre-groove having land pre-pits in a specific pattern for encoding position information like in DVD-RW.

An embodiment of the present invention makes use of the same nominal situation of existing groove-only formats, such as CD-ROM, CD-R, CD-RW, DVD-ROM, DVD-R, DVD+R, DVD-RW, and DVD+RW, but specifies a total length of the track 9 in terms of, for example, channel bits or wobbles after each rotation instead of the linear density. For DVD+RW this would be a specification on the number of wobbles after n rotations, where n is the track number. The number of wobbles after n rotations can easily be calculated for the nominal situation.

The specification for an embodiment of the present invention can then, for example, read as follows: “The actual number of wobbles after n rotations shall be equal to the nominal number of wobbles after n rotations with an accuracy of ±m wobbles for any n”. Note that “the number of wobbles after n rotations” and m need not be integers and that alternatively a specification in terms of angular position (±x radians) can be used. During mastering, the difference between the actual and the nominal number of wobbles after n rotation can be used as an error signal for adjusting the frequency of the write clock, assuming that the rotation frequency of the disc 1 is kept constant. For more accurate control, the error signal can be generated at a number of angular positions for each rotation.

Other aspects of the disc mastering constraints for an embodiment of the present invention include, for example, providing more stringent margins. Variations of the track pitch and start radius translate into variations of the linear density. For DVD+RW, the track pitch has an accuracy averaged over the information area of ±1.35% which translates in linear density variations near the outer radius of ±0.79%. This is already a substantial fraction of the maximum allowed variation of ±1.05%. An aspect of the present invention includes, for example, reducing the tolerance on the track pitch to the DVR value of ±0.83%, which reduces the effect on linear variation to ±0.49%.

The maximum allowed deviation of the start radius for DVD+RW is not specified but equals −0.83% for DVD-ROM, which translates to −0.83% variation of the linear density near the inner radius, also a significant fraction of ±1.05%. In the worst case scenario, that the start radius equals 23.8 mm instead of 24.0 mm and the track pitch equals 0.73 micrometer instead of 0.74 micrometer, the maximum deviation from the nominal linear density would be −0.99% near the outer radius. This is just within the allowed variation of ±1.05%.

FIG. 3 shows a reading device for scanning a record carrier 1. Writing and reading information on optical discs and formatting, error correcting and channel coding rules, are well known in the art, e.g. from the CD system. The apparatus of FIG. 3 is arranged for reading the record carrier 1, which record carrier 1 is identical to the record carrier 1 of FIGS. 1a and 1b. The device is provided with a read head 52 for scanning the track on the record carrier 1, and read control means comprising a drive unit 55 for rotating the record carrier 1, a read circuit 53, e.g. comprising a channel decoder and an error corrector, tracking unit 51, and a system control unit 56. The read head 52 comprises optical elements of the usual type for generating a radiation spot 66 focused on the a track of the recording layer of the record carrier 1 via a radiation beam 65, guided through optical elements. The radiation beam 65 is generated by a radiation source, e.g. a laser diode. The read head 52 further comprises a focusing actuator for focusing the radiation beam 65 on the recording layer, and a tracking actuator 59 for fine positioning of the spot 66 in radial direction on the centre of the track. The device has a positioning unit 54 for coarsely positioning the read head 52 in the radial direction on the track. The tracking actuator 59 may comprise coils for radially moving an optical element, or may be arranged for changing the angle of a reflecting element on a movable part of the read head 52, or on a part on a fixed position in case part of the optical system is mounted in a fixed position. The radiation reflected by the recording layer is detected by a detector of a usual type, e.g. a four-quadrant diode, for generating detector signals 57, including a read signal, a tracking error, and a focusing error signal. The tracking unit 51 is coupled to the read head 52 for receiving the tracking error signal from the read head 52, and for controlling the tracking actuator 59. During reading, the read signal is converted into output information, indicated by arrow 64, in the read circuit 53. The device is provided with a demodulator 50 for detecting and retrieving the address information from the wobble signal included in the detector signals 57 when scanning the servotrack of the record carrier 1. The device is further provided with a system control unit 56 for receiving commands from a controlling computer system or from a user, and for controlling the device via control lines 58, e.g. a system bus connected to the drive unit 55, the positioning unit 54, the demodulator 50, the tracking unit 51, and the read circuit 53. To this end, the system control unit comprises control circuitry, for example a microprocessor, a program memory, and control gates, for performing the procedures described below. The system control unit 56 may also be implemented as a state machine in logic circuits.

The read device of FIG. 3 is arranged for reading a disc 1 having tracks having a periodic variation, e.g. a continuous wobble. The read control unit is arranged for detecting the periodic variations and for reading in dependence thereon a predetermined amount of data from the track. In particular, the read control unit is arranged for reading information from the lead-in portion of the disc 1, and for accessing a particular ECC block on the disc 1 based on this information. The information in the lead-in portion of the disc 1 may advantageously be read during start-up. Thus, the device may initially check whether or not the disc 1 is of a kind which allows for fast access to the data contained on the disc 1, and the device may, thus, subsequently access the data on the disc 1 in a fast manner in case the disc 1 is of such a kind, or in an ordinary manner in case the disc 1 is not of such a kind.

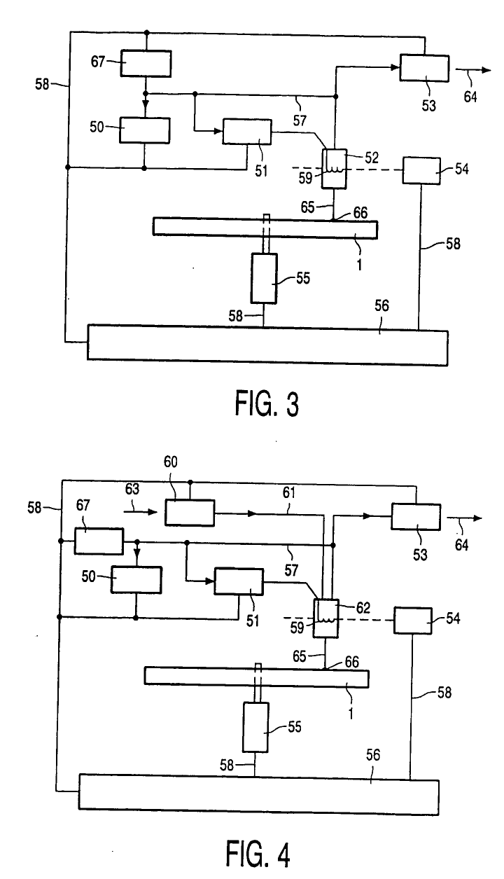

FIG. 4 shows a device for writing information on a record carrier 1 according to the invention of a type which is (re)writable in, e.g., a magneto-optical or optical manner (via phase change or dye) by means of a beam 65 of electromagnetic radiation. The device is also equipped for reading and, thus, comprises the same elements as the apparatus for reading described above in connection with FIG. 3, except that is has a write/read head 62 instead of the read head 52 of the device of FIG. 3, and recording control means which comprise the same elements as the read control means of the device of FIG. 3, and further comprises a write circuit 60 which comprises, e.g., a formatter, an error encoder, and a channel encoder. The write/read head 62 has the same function as the read head 52 together with a write function, and is coupled to the write circuit 60. The information presented to the input of the write circuit 60 (indicated by arrow 63) is distributed over logical and physical sectors according to formatting and encoding rules, and converted into a write signal 61 for the write/read head 62. The system control unit 56 is arranged for controlling the write circuit 60. In particular, the write/read head 62 is arranged for writing information in the lead-in portion of the record carrier 1 indicating that the record carrier 1 is of the kind which allows for fast access of the information on the record carrier 1.

Thus, a method of manufacturing a record carrier and a record carrier have been provided which allows for fast access to the information on the record carrier, and which is compatible with existing disc formats and drives. Furthermore, a device for recording and/or reading information on a record carrier with fast access has been provided.

1. A record carrier comprising an optical disc (1) having:
a continuous spirally wound data area (3) for recording and/or reading data at a substantially constant linear density,
a plurality of synchronizing elements in the data area (3), said plurality of synchronizing elements providing, for each error correction code (ECC) block residing on the data area (3), a fixed relation between the physical address of a given ECC block and the position on the data area of said ECC block,
a lead-in portion storing information being indicative of a specific format of the disc (1) for accessing an ECC block.

2. A record carrier according to claim 1, wherein the position of an ECC block is further defined according to a specification on the number of synchronizing elements after n rotations of the disc (1) and a calculated nominal number of synchronizing elements after n rotations, where n is the track number.

3. A record carrier according to claim 2, wherein the position of an ECC block is further defined according to an actual number of synchronizing elements after n rotations of the disc (1), equal to the nominal number of synchronizing elements after n rotations, with an accuracy of ±m synchronizing elements for any n rotations, and wherein the lead-in portion further stores information being indicative of the accuracy, m.

4. A record carrier according to claim 1, wherein the fixed relation between the physical address of an ECC block and the position on the data area (3) of said ECC block is defined in terms of a known relationship between the synchronizing elements and a track number and angle corresponding to the position of the ECC block.

5. A record carrier according to claim 1, wherein the synchronizing elements comprise at least one of wobbles, channel bits, sub-code frames, sync frames, recording frames, and physical sectors on the data area of the disc.

6. A record carrier according to claim 1, wherein the lead-in portion further stores the position of at least a substantial fraction of the ECC blocks residing on the data area (3).

7. A method for manufacturing a record carrier, the method comprising the steps of:
providing an optical disc (1) having a continuous wound data area (3) for recording and/or reading data at a substantially constant linear density,
providing a plurality of synchronizing elements in the data area (3),
providing, for each error correction code (ECC) block residing on the data area (3) and by means of said plurality of synchronizing elements, a fixed relation between the physical address of a given ECC block and the position on the data area (3) of said ECC block,
providing a lead-in portion on said optical disc (1),
storing information in said lead-in portion being indicative of a specific format of the disc (1) for accessing the ECC block.

8. A method according to claim 7, further comprising the step of defining the position of an ECC block according to a specification on the number of synchronizing elements after n rotations of the disc and a calculated nominal number of synchronizing elements after n rotations, where n is the track number.

9. A method according to claim 8, further comprising the step of defining the position of an ECC block according to an actual number of synchronizing elements after n rotations of the disc (1), equal to the nominal number of synchronizing elements after n rotations, with an accuracy of ±m synchronizing elements for any n rotations, and wherein the storing step further comprises storing information being indicative of the accuracy, m, in the lead-in portion.

10. A method according to claim 7, further comprising the step of defining the fixed relation between the physical address of a given ECC block and the position on the data area (3) of said ECC block in terms of a known relationship between the synchronizing elements and a track number and angle corresponding to the position of the ECC block.

11. A method according to claim 7, wherein the storing step further comprises the step of storing the position of at least a substantial fraction of the ECC blocks residing on the data area (3) in the lead-in portion.

12. A method according to claim 7, further comprising the step of providing a coupling between disc rotation and write clock by means of the synchronizing elements.

13. A device for recording and/or reading data on/from a record carrier, the record carrier comprising an optical disc (1) having a continuous spirally wound data area (3) for recording and/or reading data at a substantially constant linear density and a lead-in portion for storing information being indicative of a specific format of the disc (1) for accessing a given error correction code (ECC) block residing on the data area (3), the device comprising:
means (52, 53, 62) for reading information from the lead-in portion of the data area (3),
means (52, 53, 62) for accessing the position of a given ECC block for reading and/or writing said ECC block while the accessing is performed, said accessing being performed according to the information read from the lead-in portion.

14. A device according to claim 13, wherein the position of the ECC block on the data area (3) may further be defined according to an actual number of synchronizing elements after n rotations of the disc (1), equal to the a calculated nominal number of synchronizing elements after n rotations, with an accuracy of ±m synchronizing elements for any n rotations, and wherein the information in the lead-in portion of the data area (3) may further comprise information being indicative of the accuracy, m, and wherein the means (52, 53, 62) for reading information from the lead-in portion of the data area (3) are further adapted to reading information being indicative of the accuracy, m.

15. A device according to claim 13, the device being adapted to recognise a specific format of the disc (1) based on the information being read from the lead-in portion.
